(19) United States
(12) Patent Application Publication
(10) Pub. No.: US 2023/0211977 A1
(43) Pub. Date: Jul. 6, 2023

(54) ELEVATOR CALL ALLOCATION WITH STOCHASTIC MULTI-OBJECTIVE OPTIMIZATION

(71) Applicant: KONE CORPORATION, Helsinki (FI)

(72) Inventors: Juho KOKKALA, Helsinki (FI); Yue ZHOU-KANGAS, Helsinki (FI); Mirko RUOKOKOSKI, Helsinki (FI)

(73) Assignee: KONE CORPORATION, Helsinki (FI)

(21) Appl. No.: 18/120,153

(22) Filed: Mar. 10, 2023

Related U.S. Application Data
(63) Continuation of application No. PCT/FI2020/050698, filed on Oct. 22, 2020.

(51) Int. Cl. B66B 1/34; B66B 1/06

(52) U.S. Cl. CPC B66B 1/3407; B66B 1/06; B66B 2201/211; B66B 2201/212; B66B 2201/216; B66B 2201/23; B66B 2201/223

(57) ABSTRACT

Devices, methods and computer programs for elevator call allocation with stochastic multi-objective optimization are disclosed. At least some of the disclosed embodiments allow an elevator group control to take into account knowledge about possible future passenger arrivals when allocating new calls. At the same time, the new elevator calls can be allocated via optimizing multiple objectives, such as the waiting time, the time to destination, and/or the energy consumption. In other words, the invention makes it possible to both take into account the uncertainty related to future passengers and control the trade-off between different optimization objectives.

### TECHNICAL FIELD

The present disclosure relates to the field of elevators, and, more particularly, to elevator call allocation with stochastic multi-objective optimization.

### BACKGROUND

In elevator group control, allocation decisions need to be made in real-time, with the information that exists at the time of making the decision. If an allocation decision is made shortsightedly considering only the already existing calls (i.e. elevator calls that have already been registered to a set of elevators), subsequent passenger arrivals may render the original decisions suboptimal. This may be problematic, for example, in immediate allocation where allocation decisions already made cannot be changed.

Also, in real-world situations there are typically multiple passengers (usually an unknown number of them), each of whom has e.g. their own waiting time (WT) and time to destination (TTD). Yet, currently it is not possible to allocate elevator calls via optimizing multiple objectives, such as a waiting time, a time to destination, and/or an energy consumption (EC), while also taking into account the uncertainty related to future passengers. These objectives can conflict with each other, i.e. there is no elevator call allocation with which the multiple optimization objectives are at their individual best at the same time.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object of the present disclosure to allow elevator call allocation with stochastic multi-objective optimization. The foregoing and other objects are achieved by the features of the independent claims. Further implementation forms are apparent from the dependent claims, the description and the figures.

According to a first aspect of the disclosure, an apparatus for elevator call allocation in an elevator group of an elevator system is provided. The apparatus comprises at least one processor, and at least one memory including computer program code. The at least one memory and the computer program code are configured to, with the at least one processor, cause the apparatus at least to perform:

accessing a set of candidate elevator call allocation policies;

determining, for each candidate elevator call allocation policy in the set of candidate elevator call allocation policies, a set of probability distributions, the set of probability distributions comprising a probability distribution over each optimization objective in a set of optimization objectives.

transforming, for each candidate elevator call allocation policy in the set of candidate elevator call allocation policies, the set of probability distributions into a finite-dimensional vector, thereby producing a set of finite-dimensional vectors;

evaluating each candidate elevator call allocation policy in the set of candidate elevator call allocation policies based on applying a scalarization to the set of finite-dimensional vectors;

selecting a candidate elevator call allocation policy in the set of candidate elevator call allocation policies evaluated as the optimal candidate elevator call allocation policy; and

allocating an elevator call to at least one elevator car in the elevator group according to the selected candidate elevator call allocation policy.

In an implementation form of the first aspect, the transforming of the set of probability distributions into the finite-dimensional vector, for each candidate elevator call allocation policy in the set of candidate elevator call allocation policies, is performed based on at least one key performance indicator.

In an implementation form of the first aspect, the at least one key performance indicator comprises at least one of an average waiting time, an average time to destination, an average energy consumption, a percentile of a waiting time, and a percentile of a time to destination.

In an implementation form of the first aspect, the scalarization comprises an augmented Chebyshev scalarization.

In an implementation form of the first aspect, the applying of the augmented Chebyshev scalarization comprises minimizing the following function:

$${max}_{i = 1}^{n} {w}_{i} * ( {z}_{i} - {z}_{i}^{*} ) + ρ * {\sum }_{i = 1}^{n} z\_i$$

wherein z represents an n-dimensional outcome vector, n represents the number of objectives, z* represents an ideal point, ρ represents a small constant, and w represent scaling weights reflecting the importance of respective optimization objectives.

In an implementation form of the first aspect, the ideal point comprises a minimum achievable value of each optimization objective.

In an implementation form of the first aspect, the scaling weights are based on user preferences.

In an implementation form of the first aspect, an optimization objective in the set of optimization objectives comprises a waiting time, a time to destination, or an energy consumption.

In an implementation form of the first aspect, each candidate elevator call allocation policy of the set of candidate elevator call allocation policies comprises at least one of:

allocation of calls from a specific floor at a specific time interval to a specific elevator;

allocation of calls to elevators depending on the order in which the calls arrive; or

change of an elevator associated to a floor.

In an implementation form of the first aspect, the determining of the set of probability distributions for each candidate elevator call allocation policy in the set of elevator call allocation policies is performed on the basis of evaluating each candidate elevator call allocation policy of the set of candidate elevator call allocation policies in view of a set of passenger arrival scenarios, each passenger arrival scenario depicting a passenger arrival process.

In an implementation form of the first aspect, each passenger arrival scenario of the set of passenger arrival scenarios is generated based on statistical traffic forecasts modelling future passenger arrivals in the elevator system.

In an implementation form of the first aspect, when performing the evaluation of a candidate elevator call allocation policy, the at least one memory and the computer program code are further configured to, with the at least one processor, cause the apparatus at least to perform combining at least one of waiting times or times to destinations of passengers in the passenger arrival scenarios in a list.

In an implementation form of the first aspect, the determining of the set of probability distributions for each candidate elevator call allocation policy of the set of candidate elevator call allocation policies comprises, for each candidate elevator call allocation policy in the set of candidate elevator call allocation policies, determining a multivariate distribution over the set of optimization objectives and transforming the multivariate distribution into the set of probability distributions by determining marginal distributions.

According to a second aspect of the disclosure, a method of elevator call allocation is provided. The method comprises accessing, by a processor, a set of candidate elevator call allocation policies. The method further comprises determining by the processor, for each candidate elevator call allocation policy in the set of candidate elevator call allocation policies, a set of probability distributions. The set of probability distributions comprises a probability distribution over each optimization objective in a set of optimization objectives. The method further comprises transforming by the processor, for each candidate elevator call allocation policy in the set of candidate elevator call allocation policies, the set of probability distributions into a finite-dimensional vector, thereby producing a set of finite-dimensional vectors. The method further comprises evaluating by the processor, each candidate elevator call allocation policy in the set of candidate elevator call allocation policies based on applying a scalarization to the set of finite-dimensional vectors. The method further comprises selecting by the processor, a candidate elevator call allocation policy in the set of candidate elevator call allocation policies evaluated as the optimal candidate elevator call allocation policy. The method further comprises allocating by the processor, an elevator call to at least one elevator in the elevator group according to the selected candidate elevator call allocation policy.

In an implementation form of the second aspect, the transforming of the set of probability distributions into the finite-dimensional vector, for each candidate elevator call allocation policy in the set of candidate elevator call allocation policies, is performed based on at least one key performance indicator.

In an implementation form of the second aspect, the at least one key performance indicator comprises at least one of an average waiting time, an average time to destination, an average energy consumption, a percentile of a waiting time, and a percentile of a time to destination.

In an implementation form of the second aspect, the scalarization comprises an augmented Chebyshev scalarization.

In an implementation form of the second aspect, the applying of the augmented Chebyshev scalarization comprises minimizing the following function:

$${max}_{i = 1}^{n} {w}_{i} * ( {z}_{i} - {z}_{i}^{*} ) + ρ * {\sum }_{i = 1}^{n} z\_i$$

wherein z represents an n-dimensional outcome vector, n represents the number of objectives, z* represents an ideal point, ρ represents a small constant, and w represent scaling weights reflecting the importance of respective optimization objectives.

In an implementation form of the second aspect, the ideal point comprises a minimum achievable value of each optimization objective.

In an implementation form of the second aspect, the scaling weights are based on user preferences.

In an implementation form of the second aspect, an optimization objective in the set of optimization objectives comprises a waiting time, a time to destination, or an energy consumption.

In an implementation form of the second aspect, each candidate elevator call allocation policy of the set of candidate elevator call allocation policies comprises at least one of:

allocation of calls from a specific floor at a specific time interval to a specific elevator;

allocation of calls to elevators depending on the order in which the calls arrive; or

change of an elevator associated to a floor.

In an implementation form of the second aspect, the determining of the set of probability distributions for each candidate elevator call allocation policy in the set of elevator call allocation policies is performed on the basis of evaluating each candidate elevator call allocation policy of the set of candidate elevator call allocation policies in view of a set of passenger arrival scenarios, each passenger arrival scenario depicting a passenger arrival process.

In an implementation form of the second aspect, each passenger arrival scenario of the set of passenger arrival scenarios is generated based on statistical traffic forecasts modelling future passenger arrivals in the elevator system.

In an implementation form of the second aspect, when performing the evaluation of a candidate elevator call allocation policy, at least one of waiting times or times to destinations of passengers in the passenger arrival scenarios are combined in a list.

In an implementation form of the second aspect, the determining of the set of probability distributions for each candidate elevator call allocation policy of the set of candidate elevator call allocation policies comprises, for each candidate elevator call allocation policy in the set of candidate elevator call allocation policies, determining a multivariate distribution over the set of optimization objectives and transforming the multivariate distribution into the set of probability distributions by determining marginal distributions.

According to a third aspect of the disclosure, a computer program product is provided. The computer program product comprises program code configured to perform the method according to the second aspect when the program code is executed on an apparatus for elevator call allocation.

According to a fourth aspect of the disclosure, an apparatus for elevator call allocation in an elevator group of an elevator system is provided. The apparatus comprises means for:

accessing a set of candidate elevator call allocation policies;

determining for each candidate elevator call allocation policy in the set of candidate elevator call allocation policies a set of probability distributions, the set of probability distributions comprising a probability distribution over each optimization objective in a set of optimization objectives.

transforming, for each candidate elevator call allocation policy in the set of candidate elevator call allocation policies, the set of probability distributions into a finite-dimensional vector, thereby producing a set of finite-dimensional vectors;

evaluating each candidate elevator call allocation policy in the set of candidate elevator call allocation policies based on applying a scalarization to the set of finite-dimensional vectors;

selecting a candidate elevator call allocation policy in the set of candidate elevator call allocation policies evaluated as the optimal candidate elevator call allocation policy; and

allocating an elevator call to at least one elevator car in the elevator group according to the selected candidate elevator call allocation policy.

The invention allows elevator call allocation with stochastic multi-objective optimization, thereby making it possible for the elevator group control to take into account knowledge about possible future passenger arrivals when allocating new calls. At the same time, the invention further allows elevator calls to be allocated via optimizing multiple objectives, such as the waiting time, the time to destination, and/or the energy consumption. In other words, the invention makes it possible to both take into account the uncertainty related to future passengers and control the trade-off between different optimization objectives.

Many of the features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 is a block diagram illustrating an elevator system;

FIG. 2 is a block diagram illustrating an apparatus for elevator call allocation according to an embodiment of the present disclosure;

FIG. 3 illustrates a comparison of waiting time distributions using 90th percentiles according to an embodiment of the present disclosure;

FIG. 4 is a flow chart illustrating a method according to an embodiment of the present disclosure;

FIG. 5 is a flow chart illustrating a method according to another embodiment of the present disclosure; and

FIGS. 6A and 6B illustrate comparisons of candidate allocation policies according to an embodiment of the present disclosure.

In the following, identical reference signs refer to identical or at least functionally equivalent features.

### DETAILED DESCRIPTION

In the following description, reference is made to the accompanying drawings, which form part of the disclosure, and in which are shown, by way of illustration, specific aspects in which the invention may be placed. It is understood that other aspects may be utilized, and structural or logical changes may be made without departing from the scope of the invention. The following detailed description, therefore, is not to be taken in a limiting sense, as the scope of the invention is defined in the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus or device is described based on functional units, a corresponding method may include a step performing the described functionality, even if such step is not explicitly described or illustrated in the figures. Further, it is understood that the features of the various example aspects described herein may be combined with each other, unless specifically noted otherwise.

At least in some example embodiments, various data may be collected. The data may comprise statistical data about historical call allocations, the number of passengers associated with calls (or more generally the number of passengers entering/exiting the elevators), etc. Furthermore, at least in some example embodiments, origin-destination counts may be estimated based on the data collection, and/or statistical traffic forecast(s) modelling future passenger arrivals may be determined. In an example embodiment, the statistical traffic forecasts may be defined for passenger arrivals such that the realizations of the process are, for example, lists of tuples of a form (arrival timestamp, origin floor, destination floor, passenger batch size). For example, for each origin-destination pair a geometric Poisson process may be used where arrivals follow a Poisson process and the batch sizes have a geometric distribution. The parameters of the processes may be obtained, for example, from the historical statistics and recent observations. Alternatively or in addition, the statistical traffic forecasts may take into account sensor information about passengers likely to give calls in near future. In an example embodiment, a statistical traffic forecast comprises a stochastic process model. In another example embodiment, historical realized calls may be used to model the future passenger arrivals in an elevator system.

Furthermore, at least in some example embodiments, a set of passenger arrival scenarios may be generated based, for example, on the above statistical traffic forecasts, e.g. for a fixed parameter. In an example embodiment, the fixed parameter may comprise a fixed period of time or a fixed number of passenger arrivals. Further, in an example embodiment, the set of passenger arrival scenarios may be generated by randomly sampling the statistical traffic forecasts from a current point onwards. This may include uncertain information, for example, the batch sizes of existing elevator calls that have not yet been served, for the fixed parameter (for example, two minutes). It is evident that two minutes is only one possible example for the fixed period of time, and it may take other values. The number of the scenarios in the set of scenarios may take any appropriate number, for example, 1, 5, 20, 45 or any number between, for example, 5-100 etc. In another example embodiment, the set of scenarios may be generated based on historical realized calls. As an example, the historical realized calls may directly be used as the set of scenarios.

In the following examples, there may be multiple passengers (an unknown number of them), each of whom has their own waiting time and time to destination. The probability distribution and the component of the fixed dimensional vector may be formulated e.g. as follows (corresponding to waiting time):

(i) ‘per scenario’—the waiting times of different passengers may be mapped into a summary statistic (such as an average waiting time). The probability distribution is then over the uncertainty in average waiting time. The final key performance indicator or KPI (component of the fixed-dimensional vector) is then, e.g., average (over uncertainty) of average (over passengers) waiting time, or 90th percentile (over uncertainty) of average (over passengers) waiting time; or

(ii) such that the probability distribution concerns a ‘random passenger’ so that the distribution combines both variation between passengers and the uncertainty.

As an example, if there were (for one candidate call allocation policy) two scenarios, one of which has two passengers whose waiting times are 10 seconds and 20 seconds, another has only one passenger whose waiting time is 20 seconds. Under (i) the average waiting time is equally likely to be either 15 seconds or 20 seconds. Under (ii) a random passenger will have a waiting time of 10 seconds with a probability of ⅓, or a waiting time 20 seconds with a probability of ⅔.

Thus, a probability distribution generated here may be one over, e.g., waiting time of a ‘random passenger’, time to destination of a random passenger, or total energy consumption.

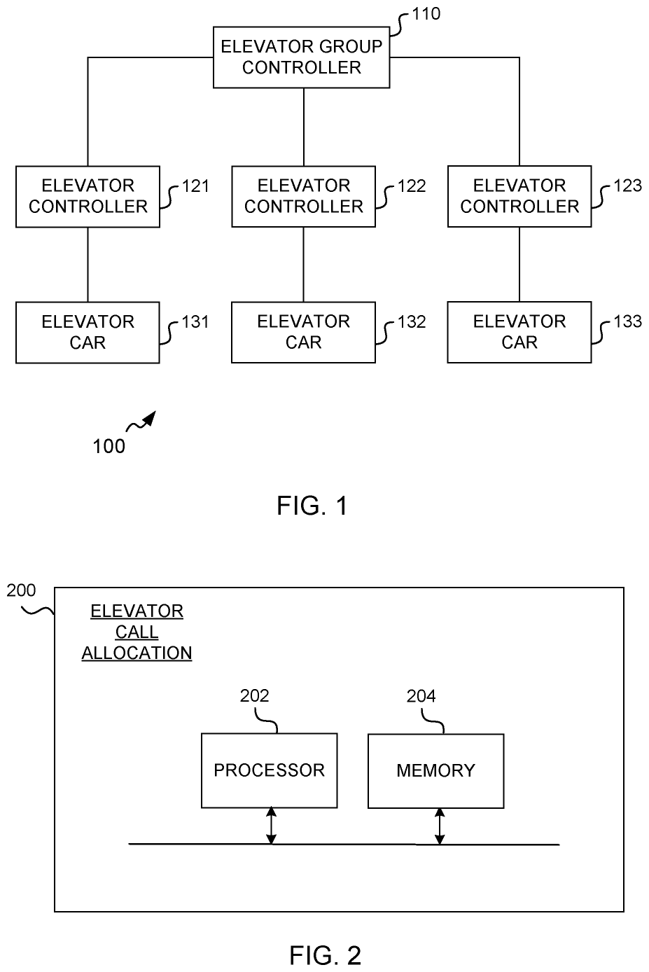

FIG. 1 is a block diagram illustrating an elevator system 100. The elevator system 100 comprises a set of elevator cars 131-133 controlled by respective elevator controllers 121-123. Each elevator controller 121-123 is connected to an elevator group controller 110.

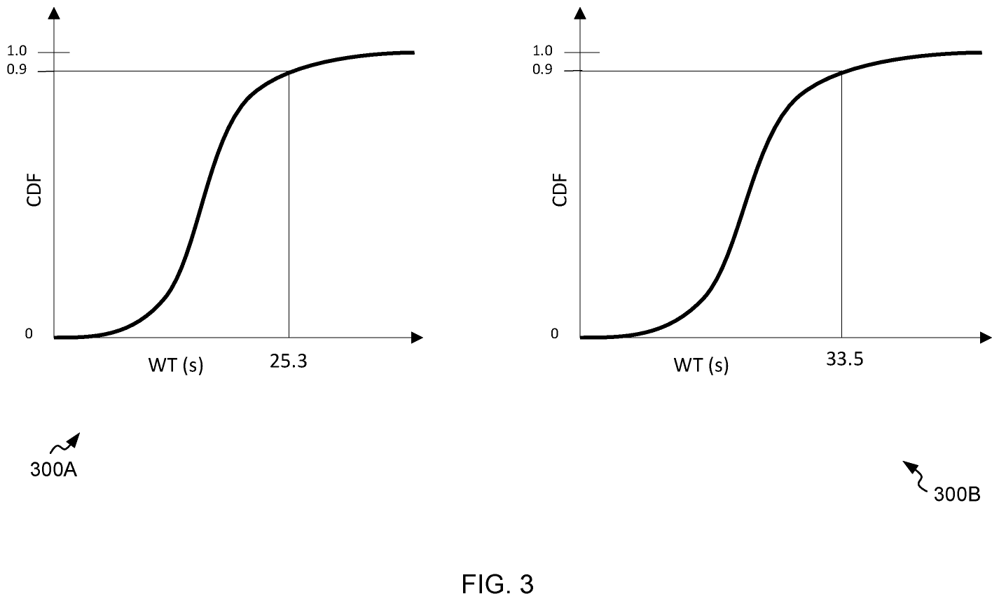

Next, an example embodiment of an apparatus 200 for elevator call allocation in an elevator group of an elevator system is described based on FIG. 2. Some of the features of the described units are optional features which provide further advantages.

FIG. 2 is a block diagram illustrating the apparatus 200 for elevator call allocation in an elevator group of an elevator system, according to an embodiment of the present disclosure. In at least some embodiments, the elevator system may comprise the elevator system 100 of FIG. 1.

The apparatus 200 comprises at least one processor or a processing unit 202, and at least one memory 220414 including computer program code and coupled to the at least one processor 202, which may be used to implement the functionalities described later in more detail.

In an example embodiment, the apparatus 200 may be comprised at least partly in an elevator group controller controlling a plurality of elevator cars, e.g. in the elevator group controller 110 of FIG. 1. In another example embodiment, the apparatus 200 may be comprised at least partly in a cloud-based service and at least some remaining parts of the apparatus 200 may be comprised in the elevator group controller.

The at least one processor 202 may include, e.g., one or more of various processing devices, such as a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The at least one memory 204 may be configured to store e.g. computer programs and the like. The at least one memory 204 may include one or more volatile memory devices, one or more non-volatile memory devices, and/or a combination of one or more volatile memory devices and non-volatile memory devices. For example, the at least one memory 204 may be embodied as magnetic storage devices (such as hard disk drives, etc.), optical magnetic storage devices, and semiconductor memories (such as mask ROM, PROM (programmable ROM), EPROM (erasable PROM), flash ROM, RAM (random access memory), etc.).

The at least one memory 204 and the computer program code may optionally be configured to, with the at least one processor 202, cause the apparatus 200 to perform receiving an indication of at least one elevator call. The indication may be caused, for example, when one or more passengers make one or more elevator calls using, for example, up/down button or a destination operating panel (DOP). When continuous call allocation is used, the indication may refer also to a trigger other than the elevator call. In an example embodiment, the indication may be received at a specific interval, for example, of 0.5 s. In an example embodiment, the procedure is triggered at given intervals (e.g. every 0.5 seconds) without receiving an indication of an elevator call.

The at least one memory 204 and the computer program code may be further configured to, with the at least one processor 202, cause the apparatus 200 to perform accessing a set of optimization objectives. Alternatively, in an embodiment, at least some of the optimization objectives may be hardcoded. An optimization objective in the set of optimization objectives may comprise e.g. a waiting time, a time to destination, and/or an energy consumption.

The at least one memory 204 and the computer program code are further configured to, with the at least one processor 202, cause the apparatus 200 to perform accessing a set of candidate elevator call allocation policies. Each candidate allocation policy defines a way to allocate elevator calls. For example, each candidate elevator call allocation policy of the set of candidate elevator call allocation policies may comprise allocation of calls from a specific floor at a specific time interval to a specific elevator, allocation of calls to elevators depending on the order in which the calls arrive, and/or change of an elevator associated to a floor. In an example embodiment, a candidate elevator call allocation policy of the set of candidate elevator call allocation policies may additionally or alternatively comprise a change of how elevator calls are allocated as a function of time. In an example embodiment, a candidate elevator call allocation policy may remain unchanged when it is applied. In another example embodiment, a candidate elevator call allocation policy may change to another candidate elevator call allocation policy within the above described fixed parameter. In another example embodiment, a candidate elevator call allocation policy may be a combination of different candidate elevator call allocation policies.

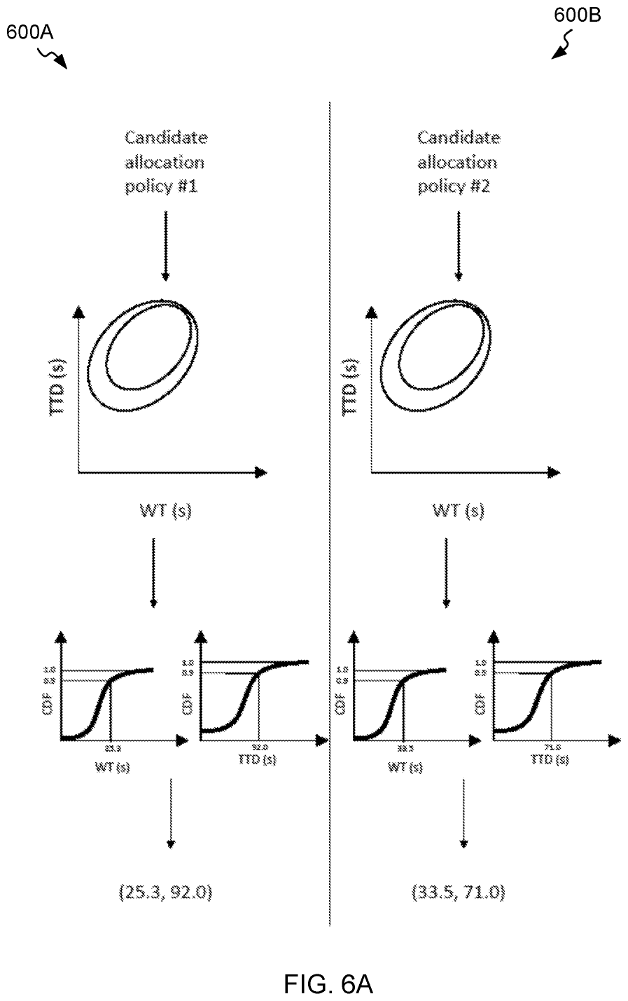

As illustrated in more detail in the example of FIG. 5, in an embodiment, during the progress of an algorithm implementing the invention, some candidate elevator call allocation policies may be created (e.g. operation 504 in FIG. 5), corresponding sets of probability distributions may be determined (operations 505-506), transformed into finite-dimensional vectors, and evaluated (operations 507-509), after which new candidate elevator call allocation policies may be generated (operation 504).

The at least one memory 204 and the computer program code are further configured to, with the at least one processor 202, cause the apparatus 200 to perform determining, for each candidate elevator call allocation policy in the set of candidate elevator call allocation policies, a set of probability distributions. Furthermore, for each candidate elevator call allocation policy in the set of candidate elevator call allocation policies, the set of probability distributions comprises a probability distribution over each optimization objective in the set of optimization objectives. That is, corresponding to one candidate elevator call allocation policy, there is one set of probability distributions, comprising one probability distribution for every optimization objective. At least in some embodiments, the determining of the set of probability distributions, for each candidate elevator call allocation policy of the set of candidate elevator call allocation policies, may be performed by determining, for each candidate elevator call allocation policy in the set of candidate elevator call allocation policies, a multivariate distribution over the set of optimization objectives, and transforming the multivariate distribution into the set of probability distributions by determining marginal distributions (i.e. taking marginal distributions of the multivariate probability distribution to form the set of probability distributions). In an embodiment, the determining of the set of probability distributions, for each candidate elevator call allocation policy in the set of candidate elevator call allocation policies, may be performed on the basis of evaluating each candidate elevator call allocation policy of the set of candidate elevator call allocation policies in view of a set of passenger arrival scenarios. As described above in more detail, each passenger arrival scenario depicts a passenger arrival process, and each passenger arrival scenario of the set of passenger arrival scenarios may be generated based on statistical traffic forecasts modelling future passenger arrivals in the elevator system 100.

In other words, determining the sets of probability distributions as described above corresponds to formulating a stochastic multi-objective optimization problem that comprises a set of allocation decision alternatives (i.e. the candidate elevator call allocation policies) and corresponding probability distributions over outcomes (i.e. optimization objectives). In yet other words, different decision alternatives are generated and their consequences are evaluated as probability distributions over the optimization objectives.

The at least one memory 204 and the computer program code are further configured to, with the at least one processor 202, cause the apparatus 200 to perform transforming, for each candidate elevator call allocation policy in the set of candidate elevator call allocation policies, the set of probability distributions into a finite-dimensional vector, thereby producing a set of finite-dimensional vectors. In an embodiment, the transforming of the set of probability distributions into the finite-dimensional vector, for each candidate elevator call allocation policy in the set of candidate elevator call allocation policies, may be performed based on at least one key performance indicator (KPI). The at least one key performance indicator may comprise e.g. an average waiting time, an average time to destination, an average energy consumption, a percentile of a waiting time (e.g. a 90th percentile of the waiting time), and/or a percentile of a time to destination (e.g. a 90th percentile of the time to destination). Transforming the sets of probability distributions into the finite-dimensional vectors allows transforming the above described stochastic multi-objective optimization problem into a deterministic multi-objective optimization problem.

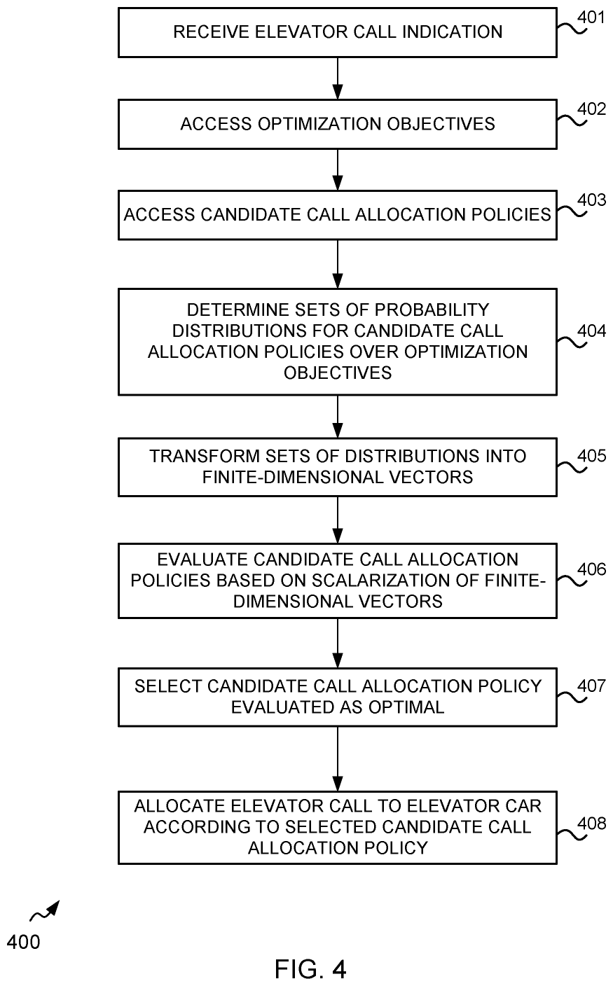

FIG. 3 illustrates a comparison of example waiting time distributions using 90th percentiles (diagrams 300A and 300B) according to an embodiment of the present disclosure. Distributions corresponding to two different candidate call allocation policies (300A, 300B) are illustrated in FIG. 3 in the form of cumulative distribution functions. The distributions are then transformed into scalars by taking the 90th percentiles. When multiple objectives are taken into account similarly, the finite-dimensional vectors are obtained.

The at least one memory 204 and the computer program code are further configured to, with the at least one processor 202, cause the apparatus 200 to perform evaluating each candidate elevator call allocation policy in the set of candidate elevator call allocation policies based on applying a scalarization to the set of finite-dimensional vectors. In an embodiment, the scalarization may comprise an augmented Chebyshev scalarization. In other words, the above described deterministic multi-objective optimization problem may be solved by using the augmented Chebyshev scalarization. As an example, applying such an augmented Chebyshev scalarization may comprise minimizing the following function:

$${max}_{i = 1}^{n} {w}_{i} * ( {z}_{i} - {z}_{i}^{*} ) + ρ * {\sum }_{i = 1}^{n} z\_i$$

wherein z represents an n-dimensional outcome vector (i.e. the above finite-dimensional vector), n represents the number of objectives, z* represents an ideal point, ρ represents a small constant, and w represent scaling weights reflecting the importance of respective optimization objectives. The ideal point z* may comprise e.g. a minimum achievable value of each optimization objective. The ideal point z* may be determined e.g. from previously generated decision alternatives (i.e. the candidate elevator call allocation policies), and recomputed if new decision alternatives are generated during the optimization. The scaling weights w may be based on e.g. user preferences (e.g. an objective that a user regards as more important is given a relatively higher weight wᵢ). In an embodiment, the scaling weights w may comprise configurable parameters.

In an example, the small constant may be any suitable small value, such as 0.0000001 or the like. Two different solutions may have the same value in the objective that maximizes the expression wᵢ*(zᵢ−zᵢ*) and thus evaluated to be equally good even if they differ in some other objectives. Thus, the role of the second term is to get the other objectives to act as ‘tiebreakers’ to ensure that ‘weakly dominated’ solutions (that are equally good according to some objective but worse according to some and not better according to any) are never selected. The constant is set to a small value so that the first term is decisive whenever there is a difference.

In an embodiment, when evaluating a candidate elevator call allocation policy, e.g. waiting times and times to destinations of passengers in the scenarios may be combined in a list. This list may, for example, be interpreted for each optimization objective as a probability distribution as such, or e.g. a set of parametric distributions or a parametric distribution may be fit to the data.

The at least one memory 204 and the computer program code are further configured to, with the at least one processor 202, cause the apparatus 200 to perform selecting a candidate elevator call allocation policy in the set of candidate elevator call allocation policies that was evaluated as the optimal candidate elevator call allocation policy.

The at least one memory 204 and the computer program code are further configured to, with the at least one processor 202, cause the apparatus 200 to perform allocating the at least one elevator call to at least one elevator car in the elevator group according to the selected candidate elevator call allocation policy.

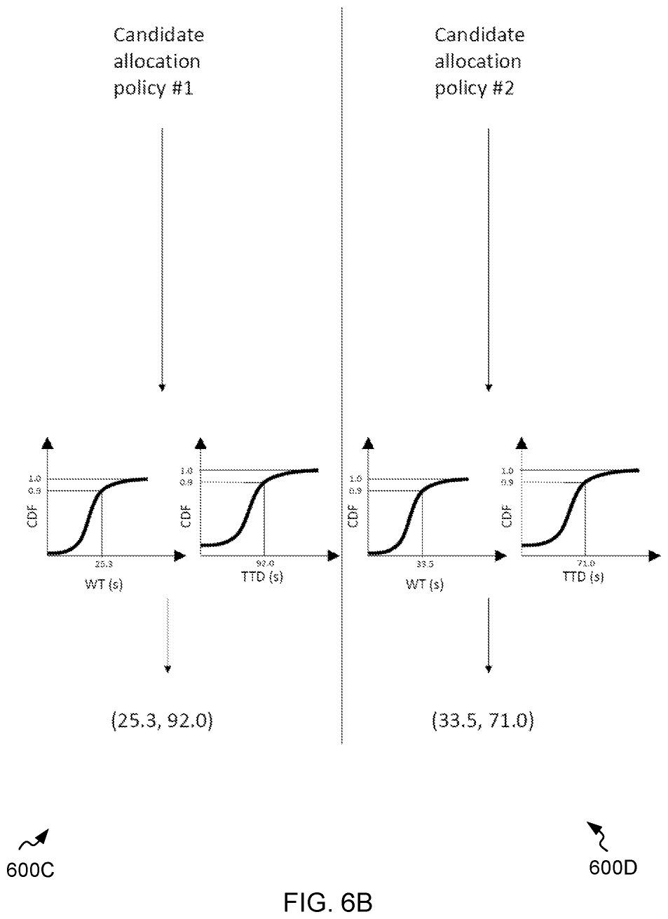

FIGS. 6A and 6B illustrate comparisons of candidate allocation policies according to an embodiment of the present disclosure, to further illustrate the probability distributions. Diagrams 600C and 600D illustrate a comparison of a candidate elevator call allocation policy #1 and a candidate elevator call allocation policy #2. A set of probability distributions comprising a probability distribution over each of two optimization objectives (waiting time (WT) and time to destination (TTD)) is determined for each of the candidate elevator call allocation policies #1 and #2. From the probability distributions in the sets of probability distributions, 90th percentiles are determined to form finite-dimensional (i.e. two-dimensional in the examples of FIGS. 6A and 6B) outcome vectors: (25.3, 92.0) for candidate elevator call allocation policy #1 and (33.5, 71.0) for candidate elevator call allocation policy #2.

In at least some example embodiments, the determining of the set of probability distributions, for each candidate elevator call allocation policy, may comprise determining a multivariate, joint probability distribution (such as the bivariate probability distribution over WT and TTD in the examples of FIGS. 6A and 6B), and taking the marginal distributions of the multivariate probability distributions to form the set of probability distributions, as illustrated by diagrams 600A and 600B.

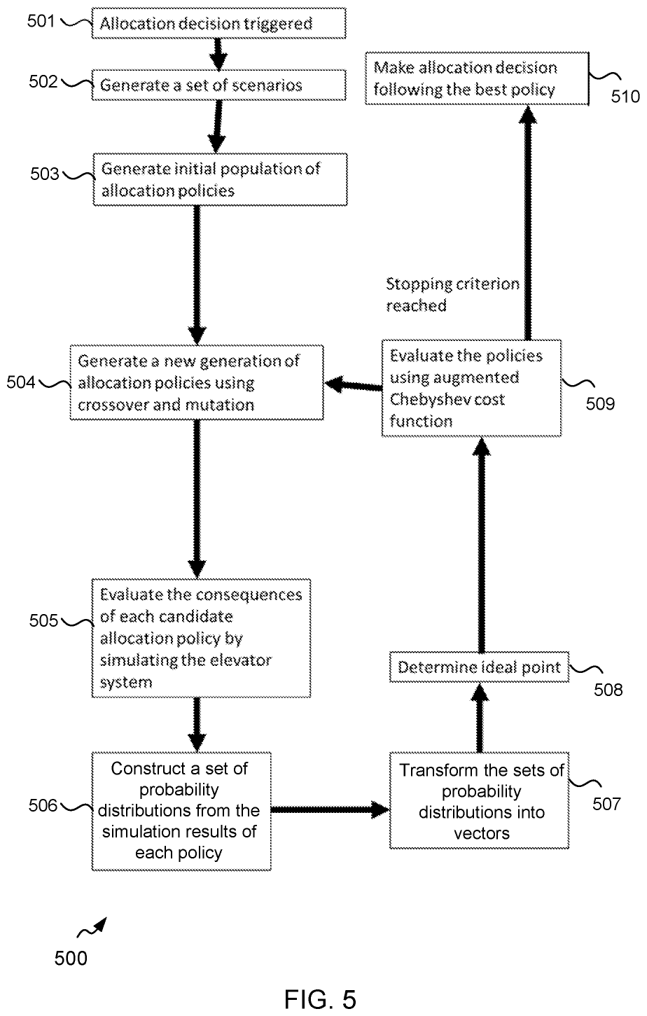

FIG. 4 is a flow chart illustrating a method 400 of elevator call allocation, according to an embodiment of the present disclosure.

At optional operation 401, an indication of at least one elevator call may be received.

At optional operation 402, a set of optimization objectives may be accessed.

At operation 403, a set of candidate elevator call allocation policies is accessed.

At operation 404, for each candidate elevator call allocation policy in the set of candidate elevator call allocation policies, a set of probability distributions is determined, such that the set of probability distributions comprises a probability distribution over each optimization objective in the set of optimization objectives.

At operation 405, the set of probability distributions is transformed, for each candidate elevator call allocation policy in the set of candidate elevator call allocation policies, into a finite-dimensional vector, thereby producing a set of finite-dimensional vectors.

At operation 406, each candidate elevator call allocation policy in the set of candidate elevator call allocation policies is evaluated based on applying a scalarization to the set of finite-dimensional vectors.

At operation 407, a candidate elevator call allocation policy in the set of candidate elevator call allocation policies that was evaluated as the optimal candidate elevator call allocation policy at operation 406, is selected.

At operation 408, the at least one elevator call is allocated to at least one elevator car in the elevator group according to the selected candidate elevator call allocation policy.

The method 400 may be repeated, for example, whenever a new elevator call occurs and/or whenever a trigger other than the elevator call is received after the elevator call has originally been received.

The method 400 may be performed by the apparatus 200. The operations 401-408 can, for example, be performed by the at least one processor 202 and the memory 204. Further features of the method 400 directly result from the functionalities and parameters of the apparatus 200 and thus are not repeated here. The method 400 can be performed by a computer program.

FIG. 5 is a flow chart illustrating a method 500 according to another embodiment of the present disclosure. More specifically, FIG. 5 illustrates an implementation of the invention with genetic algorithms using scenario-based optimization of policies. A genetic algorithm is a search heuristic that reflects the process of natural selection where the fittest individuals are selected for reproduction in order to produce offspring of the next generation. Genetic algorithms may be used to generate solutions to optimization and search problems by relying on biologically inspired operators such as mutation, crossover and selection. Here, mutation is a genetic operator used to maintain genetic diversity from one generation of a population of genetic algorithm chromosomes to the next, whereas crossover (also called recombination) is a genetic operator used to combine the genetic information of two parents to generate new offspring. Selection is the stage of a genetic algorithm in which individual genomes are chosen from a population for later breeding using the crossover operator.

First, an allocation decision is triggered at operation 501. The optimization begins with generating the scenarios, operation 502. Then, an initial population of allocation policies is generated, operation 503. At each iteration of the genetic algorithm, the allocation policies are evaluated by simulating them with each scenario in the scenario set, operation 505. Then, sets of probability distributions are fit to the results, or multivariate probability distributions are fit to the results and converted to sets of probability distributions, operation 506, and the sets of distributions are converted to vectors, operation 507. The ideal point may be determined or updated based on the new set of outcome vectors, operation 508. Then, each allocation policy is evaluated using the above described augmented Chebyshev scalarization, operation 509. If a stopping criterion (e.g. a maximum number of generations or no improvement) is fulfilled, the optimization stops and the allocation decision is made using the best policy, operation 510. Otherwise, the method proceeds to operation 504, and a next generation is produced using crossover and mutation operations.

The method 500 may be performed by the apparatus 200. The operations 501-510 can, for example, be performed by the at least one processor 202 and the memory 204. Further features of the method 500 directly result from the functionalities and parameters of the apparatus 200 and thus are not repeated here. The method 500 can be performed by a computer program.

The functionality described herein can be performed, at least in part, by one or more computer program product components such as software components. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (CPUs).

Any range or device value given herein may be extended or altered without losing the effect sought. Further, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of example embodiments. Although various embodiments have been described above with a certain degree of particularity, or with reference to one or more individual embodiments, those skilled in the art could make numerous alterations to the disclosed embodiments without departing from the scope of this specification.

1. An apparatus for elevator call allocation in an elevator group of an elevator system, the apparatus comprising:
at least one processor; and
at least one memory including computer program code;
the at least one memory and the computer program code being configured to, with the at least one processor, cause the apparatus at least to perform:
accessing a set of candidate elevator call allocation policies;
determining, for each candidate elevator call allocation policy in the set of candidate elevator call allocation policies, a set of probability distributions, the set of probability distributions comprising a probability distribution over each optimization objective in a set of optimization objectives;
transforming, for each candidate elevator call allocation policy in the set of candidate elevator call allocation policies, the set of probability distributions into a finite-dimensional vector, thereby producing a set of finite-dimensional vectors;
evaluating each candidate elevator call allocation policy in the set of candidate elevator call allocation policies based on applying a scalarization to the set of finite-dimensional vectors;
selecting a candidate elevator call allocation policy in the set of candidate elevator call allocation policies evaluated as the optimal candidate elevator call allocation policy; and
allocating an elevator call to at least one elevator car in the elevator group according to the selected candidate elevator call allocation policy.

2. The apparatus according to claim 1, wherein the transforming of the set of probability distributions into the finite-dimensional vector, for each candidate elevator call allocation policy in the set of candidate elevator call allocation policies, is performed based on at least one key performance indicator.

3. The apparatus according to claim 2, wherein the at least one key performance indicator comprises at least one of an average waiting time, an average time to destination, an average energy consumption, a percentile of a waiting time, and a percentile of a time to destination.

4. The apparatus according to claim 1, wherein the scalarization comprises an augmented Chebyshev scalarization.

5. The apparatus according to claim 4, wherein the applying of the augmented Chebyshev scalarization comprises minimizing the following function:
$${max}_{i = 1}^{n} {w}_{i} * ( {z}_{i} - {z}_{i}^{*} ) + ρ * {\sum }_{i = 1}^{n} z\_i$$
wherein z represents an n-dimensional outcome vector, n represents the number of objectives, z* represents an ideal point, ρ represents a small constant, and w represent scaling weights reflecting the importance of respective optimization objectives.

6. The apparatus according to claim 5, wherein the ideal point comprises a minimum achievable value of each optimization objective.

7. The apparatus according to claim 5, wherein the scaling weights are based on user preferences.

8. The apparatus according to claim 1, wherein an optimization objective in the set of optimization objectives comprises a waiting time, a time to destination, or an energy consumption.

9. The apparatus according to claim 1, wherein each candidate elevator call allocation policy of the set of candidate elevator call allocation policies comprises at least one of:
allocation of calls from a specific floor at a specific time interval to a specific elevator;
allocation of calls to elevators depending on the order in which the calls arrive; or
change of an elevator associated to a floor.

10. The apparatus according to claim 1, wherein the determining of the set of probability distributions for each candidate elevator call allocation policy in the set of elevator call allocation policies is performed on the basis of evaluating each candidate elevator call allocation policy of the set of candidate elevator call allocation policies in view of a set of passenger arrival scenarios, each passenger arrival scenario depicting a passenger arrival process.

11. The apparatus according to claim 10, wherein each passenger arrival scenario of the set of passenger arrival scenarios is generated based on statistical traffic forecasts modelling future passenger arrivals in the elevator system.

12. The apparatus according to claim 10, wherein when performing the evaluation of a candidate elevator call allocation policy, the at least one memory and the computer program code are further configured to, with the at least one processor, cause the apparatus at least to perform combining at least one of waiting times or times to destinations of passengers in the passenger arrival scenarios in a list.

13. The apparatus according to claim 1, wherein the determining of the set of probability distributions for each candidate elevator call allocation policy of the set of candidate elevator call allocation policies comprises, for each candidate elevator call allocation policy in the set of candidate elevator call allocation policies, determining a multivariate distribution over the set of optimization objectives and transforming the multivariate distribution into the set of probability distributions by determining marginal distributions.

14. A method of elevator call allocation, comprising:
accessing, by a processor, a set of candidate elevator call allocation policies;
determining by the processor, for each candidate elevator call allocation policy in the set of candidate elevator call allocation policies, a set of probability distributions, the set of probability distributions comprising a probability distribution over each optimization objective in a set of optimization objectives;
transforming by the processor, for each candidate elevator call allocation policy in the set of candidate elevator call allocation policies, the set of probability distributions into a finite-dimensional vector, thereby producing a set of finite-dimensional vectors;
evaluating, by the processor, each candidate elevator call allocation policy in the set of candidate elevator call allocation policies based on applying a scalarization to the set of finite-dimensional vectors;
selecting, by the processor, a candidate elevator call allocation policy in the set of candidate elevator call allocation policies evaluated as the optimal candidate elevator call allocation policy; and
allocating, by the processor, an elevator call to at least one elevator car in the elevator group according to the selected candidate elevator call allocation policy.

15. The method according to claim 14, wherein the transforming of the set of probability distributions into the finite-dimensional vector, for each candidate elevator call allocation policy in the set of candidate elevator call allocation policies, is performed based on at least one key performance indicator.

16. The method according to claim 15, wherein the at least one key performance indicator comprises at least one of an average waiting time, an average time to destination, an average energy consumption, a percentile of a waiting time, and a percentile of a time to destination.

17. The method according to claim 14, wherein the scalarization comprises an augmented Chebyshev scalarization.

18. The method according to claim 16, wherein the applying of the augmented Chebyshev scalarization comprises minimizing the following function:
$${max}_{i = 1}^{n} {w}_{i} * ( {z}_{i} - {z}_{i}^{*} ) + ρ * {\sum }_{i = 1}^{n} z\_i$$
wherein z represents an n-dimensional outcome vector, n represents the number of objectives, z* represents an ideal point, ρ represents a small constant, and w represent scaling weights reflecting the importance of respective optimization objectives.

19. The method according to claim 18, wherein the ideal point comprises a minimum achievable value of each optimization objective.

20. The method according to claim 18, wherein the scaling weights are based on user preferences.

21. The method according to claim 14, wherein an optimization objective in the set of optimization objectives comprises a waiting time, a time to destination, or an energy consumption.

22. The method according to claim 14, wherein each candidate elevator call allocation policy of the set of candidate elevator call allocation policies comprises at least one of:
allocation of calls from a specific floor at a specific time interval to a specific elevator;
allocation of calls to elevators depending on the order in which the calls arrive; or
change of an elevator associated to a floor.

23. The method according to claim 14, wherein the determining of the set of probability distributions for each candidate elevator call allocation policy in the set of elevator call allocation policies is performed on the basis of evaluating each candidate elevator call allocation policy of the set of candidate elevator call allocation policies in view of a set of passenger arrival scenarios, each passenger arrival scenario depicting a passenger arrival process.

24. The method according to claim 23, wherein each passenger arrival scenario of the set of passenger arrival scenarios is generated based on statistical traffic forecasts modelling future passenger arrivals in the elevator system.

25. The method according to claim 23, wherein when performing the evaluation of a candidate elevator call allocation policy, at least one of waiting times or times to destinations of passengers in the passenger arrival scenarios are combined in a list.

26. The method according to claim 14, wherein the determining of the set of probability distributions for each candidate elevator call allocation policy of the set of candidate elevator call allocation policies comprises, for each candidate elevator call allocation policy in the set of candidate elevator call allocation policies, determining a multivariate distribution over the set of optimization objectives and transforming the multivariate distribution into the set of probability distributions by determining marginal distributions.

27. A computer program product comprising program code configured to perform the method according to claim 14 when the program code is executed on an apparatus for elevator call allocation.
